(19) United States
(12) Patent Application Publication
(10) Pub. No.: US 2003/0070874 A1
(43) Pub. Date: Apr. 17, 2003

(54) Emergency evacuation system

(76) Inventor: Seong Woong Kim, Flushing, NY (US)

Correspondence Address: Ralph W. Selitto Jr., P.O. Box 1477, Edison, NJ, 08818-1477, US

(21) Appl. No.: 10/044,188

(22) Filed: Jan. 11, 2002

Related U.S. Application Data
(60) Provisional application No. 60/328,851, filed on Oct. 12, 2001.

(51) Int. Cl. A62B 1/16

(52) U.S. Cl. 182/82; 182/37

(57) ABSTRACT

A system adapted for use in evacuating a building includes a track assembly mounted to an exterior wall of the building. More particularly, the track assembly extends vertically along the exterior wall so as to be accessible by a user from the building. The track assembly is designed to permit the user to descend along the track assembly at a predetermined speed when the user is engaged to the track assembly through an engaging mechanism.

### CROSS-REFERENCE TO RELATED APPLICATION

This application is a non-provisional application relating to U.S. Provisional Application Serial No. 60/328,851 filed Oct. 12, 2001.

### FIELD OF THE INVENTION

The present invention relates to emergency evacuation systems and, more particularly, to an emergency evacuation system adapted for use in evacuating a building or the like.

### BACKGROUND OF THE INVENTION

Recurring disasters involving fires in high-rise buildings have made clear the need for an emergency evacuation system for use by occupants in quickly evacuating such buildings. While various fire escape devices (e.g., externally mounted stairways, internal stairwells, etc.) have previously been provided, they are not adapted for use in quickly evacuating high-rise buildings.

### SUMMARY OF THE INVENTION

The present invention overcomes the disadvantages and shortcomings of the prior art discussed above by providing a new and improved system adapted for use in evacuating a building or the like. More particularly, the system includes a track assembly mounted to an exterior wall of the building and extending vertically along the exterior wall so as to be accessible by a user from the building. The track assembly is designed to permit the user to descend along the track assembly at a predetermined speed when the user is movably engaged to the track assembly through an engaging mechanism.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic view of a building which is equipped with an emergency evacuation system constructed in accordance with the present invention;

FIG. 2 is a side elevational view of a section of the emergency evacuation system shown in FIG. 1;

FIG. 3 is a perspective view of a harness of the emergency evacuation system shown in FIG. 1; and

FIG. 4 is a cross-sectional view, taken along section line 4-4 and looking in the direction of the arrows, of the emergency evacuation system shown in FIG. 1.

### DETAILED DESCRIPTION OF THE EXEMPLARY EMBODIMENT

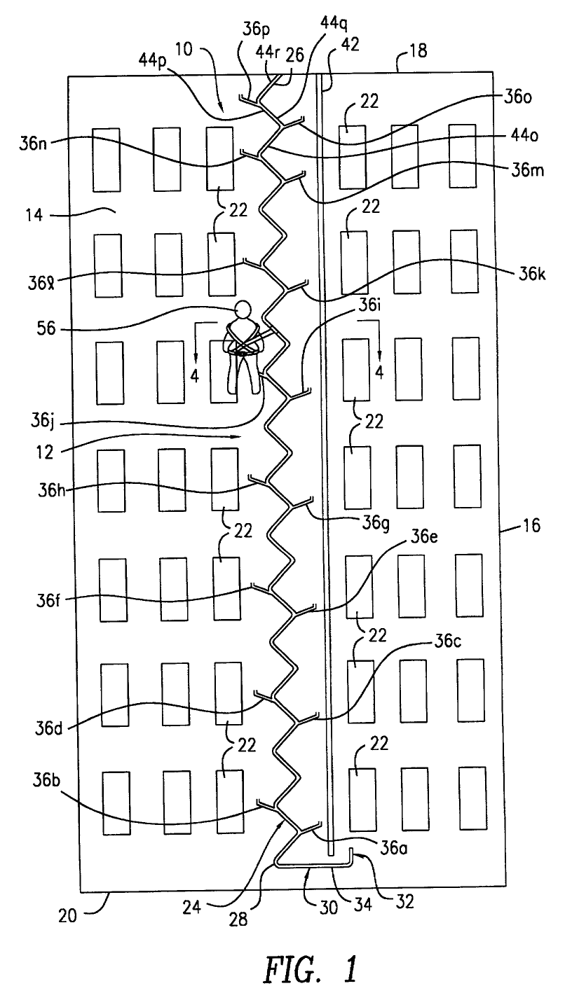

FIG. 1 shows an emergency evacuation system 10 constructed in accordance with the present invention. The emergency evacuation system 10 includes a track assembly 12 securely attached to an exterior wall 14 of a building 16, which has a top 18 and a bottom 20. More particularly, the track assembly 12 is mounted to the exterior building wall 14 at a location such that it is accessible by occupants from a predetermined set of windows 22 of the building 16. The track assembly 12 includes a sinuous or zigzag-shaped track 24 having upper and lower ends 26, 28 and extending vertically from the top 18 of the building 16 to the bottom 20 of the building 16. A lower linear track 30 extends substantially horizontally from the lower end 28 of the sinuous track 24, while a vertical track 32 projects vertically from an end 34 of the lower track 30. The track assembly 12 is also provided with a plurality of lateral tracks 36a-36p arranged at predetermined locations along the length of the sinuous track 24. Each of the lateral tracks 36a-36p includes an entry point 38, which is located adjacent to a corresponding one of the windows 22 of the building 16, and a lead-in section 40, which is connected to the sinuous track 24. A vertical rail 42 extends from the bottom 20 of the building 16 to the top 18 of the building 16 along the length of the sinuous track 24 such that it can be grasped by a user, as will be discussed in greater detail hereinafter.

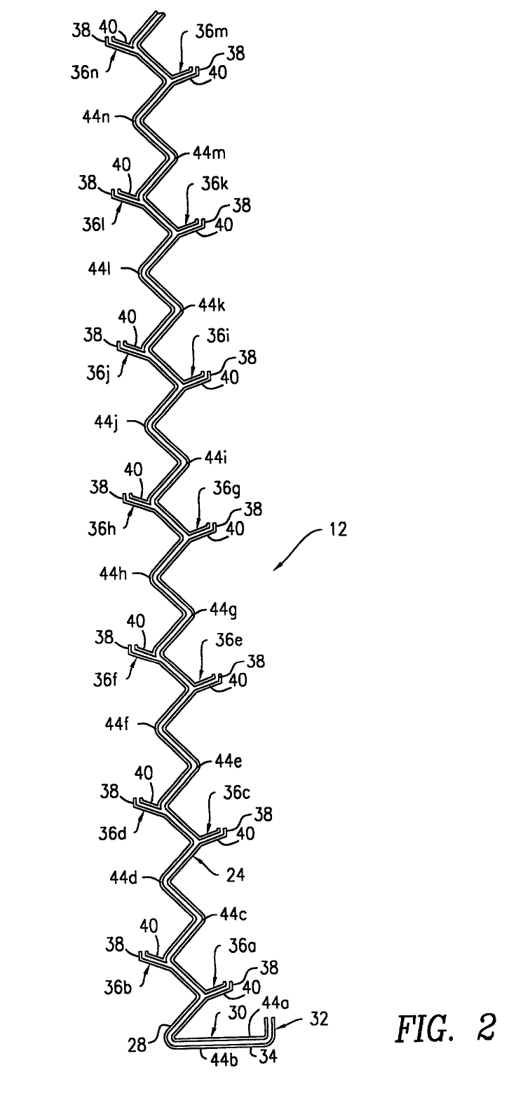

Referring primarily to FIGS. 1 and 2, the track assembly 12 is constructed from a plurality of rails 44a-44r. More particularly, each of the sinuous track 24, the lower track 30, the vertical track 32 and the lateral tracks 36a-36p is formed by a corresponding pair of the rails 44a-44r. For instance, sections of the rails 44a, 44b define the lower track 30 and the vertical track 32. Similarly, sections of the rails 44a-44r define the sinuous track 24. The lateral track 36a is formed by sections of the rails 44a, 44c, while the lateral track 36b is formed by sections of the rails 44b, 44d. Each of the remaining lateral tracks 36c-36p is formed by a corresponding pair of the rails 44d-44r.

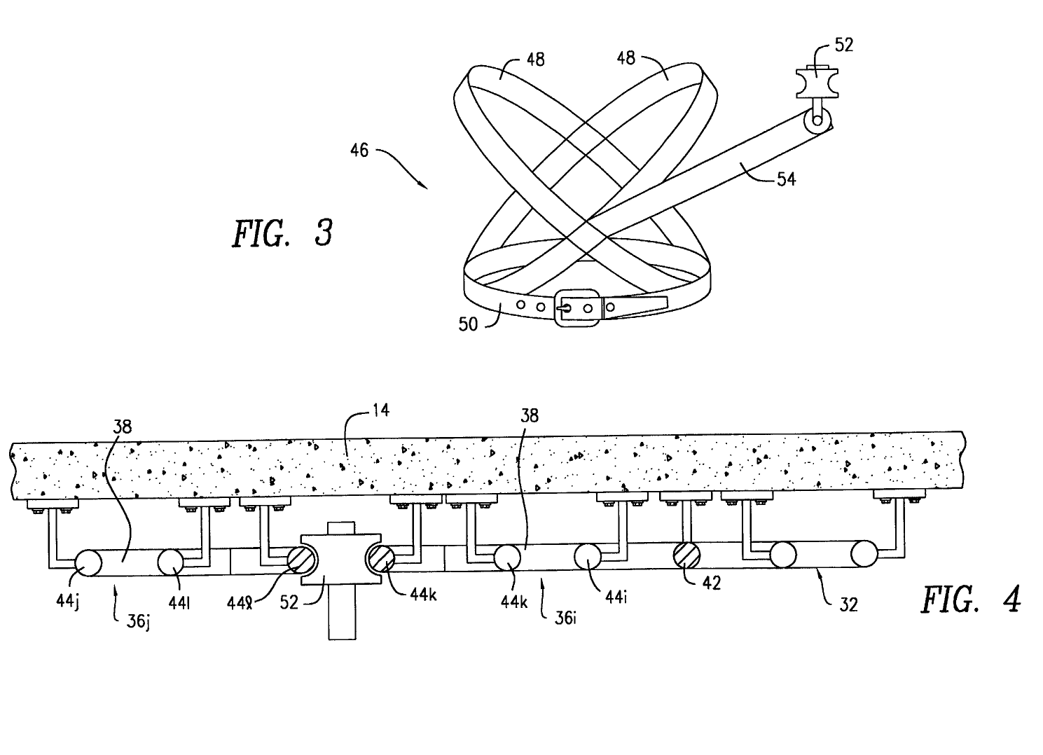

Now referring to FIG. 3, there is shown a harness 46 adapted to be worn by a user prior to accessing the track assembly 12. More particularly, the harness 46 includes a pair of straps 48 sized and shaped so as to be worn over the shoulders of a user. The harness 46 also includes a waist strap 50 sized and shaped so as to be worn over the waist of a user. A wheel 52 is securely attached to the harness by a connector 54. The wheel 54 is sized and shaped so as to glide or slide in the tracks 24, 30, 32, 36a-36p of the track assembly 12 between a corresponding pair of the rails 44a-44r (see FIG. 4).

In order to evacuate the building 16 using the track assembly 12, the harness 46 is put on a user 56 (see FIG. 1). From one of the windows 22, the user 56 reaches out to the track assembly 12 in order to insert the wheel 52 of the harness 46 into the entry point 38 of an adjacent one of the lateral tracks 36a-36p (e.g., the lateral track 36k). After the wheel 52 is properly inserted into the entry point 38, the user 56 lunges out from the window 22. As a result, the wheel 52 moves down along the lead-in section 40 of the lateral track 36k into the sinuous track 24. Due to the shape of the sinuous track 24, the user 56 is able to descend along the sinuous trace 24 at a relatively rapid, yet safe, speed. During the descent, the user 56 can grasp the vertical rail 42 so as to decrease the descending speed and/or to maintain stability. When the wheel 52 reaches the lower end 28 of the sinuous track 24, it moves into the lower track 30. In this regard, the lower track 30 is preferably located at a predetermined elevation such that when the wheel 52 is in the lower track 30, the user 56 is suspended from the ground, thereby preventing the user 56 from colliding with the ground and hence preventing injury to the user 56. The wheel 52 is taken out from the lower track 30 through the vertical track 32, thereby disengaging the user 56 from the track assembly 12.

It should be appreciated that the present invention provides numerous advantages over the prior art discussed above. For instance, because the sinuous track 24 is sized and shaped so as to permit a user to descend at a rapid, safe speed, the emergency evacuation system 10 allows quick evacuation of a building. Moreover, the track assembly 12 is adapted to be simultaneously used by multiple users, thereby permitting mass evacuation of a building. In addition, because the vertical track 32 is oriented vertically, it functions as a stop for the wheel 52 (i.e., it prevents the wheel 52 from accidentally dislodging from the track assembly 12).

It should be noted that the present invention can have numerous modifications and variations. For instance, the vertical rail 42 can be eliminated or replaced with other mechanisms. The size and shape of the sinuous track 24 can also be modified such that a user can descend in a different speed. In addition, the emergency evacuation system 10 can be modified such that one or more of the tracks 24, 30, 32, 36a-36p of the track assembly 12 is constructed of a single rail or multiple (i.e., more than two) rails. One or more of the lateral tracks 36a-36p, the lower track 30 and the vertical track 32 can also be eliminated or replaced with other mechanisms. Moreover, the harness 46 can be replaced with other mechanisms for movably securing a user to the track assembly 12.

It will be understood that the embodiment described herein is merely exemplary and that a person skilled in the art may make many variations and modifications without departing from the spirit and scope of the invention. All such variations and modifications, including those discussed above, are intended to be included within the scope of the invention as defined in the appended claims.

I claim:

1. Apparatus adapted for use in evacuating a building, comprising a track assembly mounted to an exterior wall of a building, said track assembly extending vertically along the exterior wall so as to be accessible by a user from the building, said track assembly being sized and shaped so as to permit the user to descend along said track assembly at a predetermined speed when said user is engaged to said track assembly through engaging means.

2. The apparatus of claim 1, wherein said track assembly includes a first track movably engageable by an engaging member of the engaging means such that the engaging member can glide along said first track at the predetermined speed.

3. The apparatus of claim 2, wherein said fist track has a sinuous shape.

4. The apparatus of claim 3, wherein said first track extends vertically from a first location positioned adjacent to a top of the building to a second location positioned adjacent to a bottom of the building.

5. The apparatus of claim 4, wherein said first track includes at least a pair of first rail sections defining a descending path therebetween, the engaging member being movable along said descending path between said first rail sections.

6. The apparatus of claim 5, wherein said track assembly includes a plurality of second tracks extending generally upwardly from said first track for receiving the engaging member of the engaging means.

7. The apparatus of claim 6, wherein each of said second tracks is positioned along the exterior wall of the building so as to be accessible by a user from a window of the building.

8. The apparatus of claim 7, wherein each of said second tracks includes an entry point for receiving the engaging member of the engaging means and a lead-in section connected to the first track for permitting the engaging member to move into said first track from said entry point.

9. The apparatus of claim 8, wherein each of said second tracks includes at least a pair of second rail sections defining an entry path such that the engaging member is movable along the entry path between said second rail sections.

10. The apparatus of claim 9, wherein said track assembly includes a third track for permitting the engaging member to exit from said track assembly.

11. The apparatus of claim 10, wherein said third track is oriented in a vertical manner and includes at least a pair of third rail sections engageable by the engaging member.

12. The apparatus of claim 11, wherein said track assembly includes a fourth track extending between said first track and said third track.

13. The apparatus of claim 12, wherein said fourth track is oriented in a substantially horizontal manner and includes at least a pair of fourth rail sections engageable by the engaging member.

14. In combination, a track assembly mounted to an exterior wall of a building, said track assembly extending vertically along the exterior wall so as to be accessible by a user from the building; and securing means for movably securing the user to said track assembly, said track assembly being sized and shaped so as to permit the user to descend along said track assembly at a predetermined speed when said securing means is engaged with said track assembly.

15. The combination of claim 14, wherein said track assembly includes a first track having a sinuous shape; and said securing means includes an engaging member for movably engaging said first track such that said engaging member can glide along said first track at said predetermined speed.

16. The combination of claim 15, wherein said first track includes at least a pair of first rail sections defining a first path therebetween, said engaging member being movable along said first path between said first rail sections.

17. The combination of claim 16, wherein said track assembly includes a plurality of second tracks extending generally upwardly from said first track for receiving said engaging member, each of said second tracks being positioned along the exterior wall of the building so as to be accessible by the user from a window of the building.

18. The combination of claim 17, wherein each of said second tracks includes an entry point for receiving said engaging member and a lead-in section connected to said first track for permitting said engaging member to move into said first track from said entry point, each of said second tracks including at least a pair of second rail sections defining a second path such that said engaging member is movable along said second path between said second rail sections.

19. The combination of claim 18, wherein said track assembly includes a third track for permitting said engaging member to exit said track assembly, said third track being oriented in a vertical manner and including at least a pair of third rail sections engageable by said engaging member.

20. The combination of claim 19, wherein said track assembly includes a fourth track extending between said first track and said third track, said fourth track being oriented in a substantially horizontal manner and including at least a pair of fourth rail sections engageable by said engaging member.

21. The combination of claim 14, wherein said securing means includes a harness sized and shaped so as to be worn by a user, said engaging member including a wheel engageable with said track assembly.
